(19) United States
(12) Patent Application Publication
(10) Pub. No.: US 2025/0020846 A1
(43) Pub. Date: Jan. 16, 2025

(54) POLARIZING PLATE AND OPTICAL DISPLAY APPARATUS

(71) Applicant: SAMSUNG SDI CO., LTD., Yongin-si (KR)

(72) Inventors: Jung Hun YOU, Suwon-si (KR); Bong Choon KIM, Suwon-si (KR); Seong Hoon LEE, Suwon-si (KR)

(21) Appl. No.: 18/763,839

(22) Filed: Jul. 3, 2024

(30) Foreign Application Priority Data
Jul. 4, 2023 (KR) 10-2023-0086333

(51) Int. Cl. G02B 5/30; G02F 1/1335; G02F 1/13363

(52) U.S. Cl. CPC G02B 5/3083; G02B 5/3025; G02F 1/133528; G02F 1/133637; G02F 2201/50

(57) ABSTRACT

A polarizing plate for an optical display apparatus includes: a polarizer; and a retardation layer laminated on one surface of the polarizer, wherein the retardation layer includes a retardation film satisfying nx>nz>ny at a wavelength of 550 nm (Here, nx, ny, and nz refer to a refractive index of the retardation film in a slow axis direction, a refractive index of the retardation film in a fast axis direction, and a refractive index of the retardation film in a thickness direction at a wavelength of 550 nm.), an orientation direction of a main chain of a resin contained in the retardation film is about −5° to about +5° relative to a light absorption axis of the polarizer, and the retardation film has a degree of biaxiality of about 0.3 to about 0.7 at a wavelength of 550 nm.

### CROSS-REFERENCE TO RELATED APPLICATION

The present application claims priority to and the benefit of Korean Patent Application No. 10-2023-0086333, filed on Jul. 4, 2023, in the Korean Intellectual Property Office, the entire content of which is incorporated herein by reference.

### BACKGROUND

### 1. Field

One or more embodiments of the present disclosure relate to a polarizing plate and an optical display apparatus including the polarizing plate.

### 2. Description of the Related Art

A liquid crystal display apparatus is a panel for an optical display apparatus and includes a liquid crystal panel, a viewer-side polarizer laminated on an upper surface of the liquid crystal panel, and a light source-side polarizer laminated on a lower surface of the liquid crystal panel. Among driving methods of liquid crystal panels, a transverse electric field method is a method in which a liquid crystal compound responds in a direction into a substrate surface by an electric field including a component that is approximately parallel to the substrate surface of the liquid crystal panel. Transverse electric field methods include in-plane switching (IPS) and fringe-field switching (FFS) methods. The transverse electric field method may widen a contrast ratio and a viewing angle and minimize color changes by providing a retardation layer between a liquid crystal panel and a polarizer.

According to one comparative embodiment in the art, the retardation layer may be a laminate of a +C layer and a +A layer. For example, a polarizing plate may be laminated in the order of a polarizer, a +C layer, an adhesive layer, and a +A layer. However, this polarizing plate is provided with two retardation layers, which are the +C layer and +A layer. Therefore, to provide a polarizing plate-thinning effect, it may be beneficial to make the retardation layer a single layer.

### SUMMARY

One or more aspects of embodiments of the present disclosure are directed to a polarizing plate that has a single-layer retardation film, improves visibility across all azimuths, and minimizes color changes.

One or more aspects of embodiments of the present disclosure are directed to a polarizing plate that has a single-layer retardation film and reduced light transmittance across all azimuths.

One or more aspects of embodiments of the present disclosure are directed to a polarizing plate that has an excellent thickness-thinning effect by having a single-layer retardation film.

One or more aspects of embodiments of the present disclosure are directed to a polarizing plate that has a single-layer retardation film and allows roll-to-roll manufacturing.

Additional aspects will be set forth in part in the description which follows and, in part, will be apparent from the description, or may be learned by practice of the presented embodiments of the disclosure.

According to one or more embodiments of the present disclosure, a polarizing plate is provided.

The polarizing plate includes a polarizer and a retardation layer on (e.g., laminated on) a (e.g., one) surface of the polarizer, wherein the retardation layer includes a retardation film satisfying nx>nz>ny at a wavelength of 550 nm (Here, nx, ny, and nz refer to a refractive index of the retardation film in a slow axis direction, a refractive index of the retardation film in a fast axis direction, and a refractive index of the retardation film in the thickness direction at a wavelength of 550 nm, respectively.), an orientation direction of a main chain of a resin contained in the retardation film is about −5° to about +5° relative to a light absorption axis of the polarizer, and the retardation film has a degree of biaxiality of about 0.3 to about 0.7 at a wavelength of 550 nm.

According to one or more embodiments of the present disclosure, an optical display apparatus includes the polarizing plate.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and benefits of the present disclosure will become more apparent to those of ordinary skill in the art from the following exemplary embodiments thereof described in detail with reference to the accompanying drawings, in which:

FIG. 1 shows a cross-sectional view of a polarizing plate according to one or more embodiments of the present disclosure;

FIG. 2 shows a cross-sectional view of a polarizing plate according to one or more embodiments of the present disclosure;

FIG. 3 shows light transmittance values (Y-axis, units: %) according to degrees of biaxiality (NZ) of a retardation film at a wavelength of 550 nm and the in-plane retardation (X-axis, units: nm) of the retardation film at a wavelength of 550 nm when a polarizing plate is mounted and driven in a transverse electric field method, wherein in FIG. 3, ▪ is the light transmittance when the NZ of the retardation film is 0.4 at a wavelength of 550 nm, ● is the light transmittance when the NZ of the retardation film is 0.5 at a wavelength of 550 nm, and ▴ is the light transmittance when the NZ of the retardation film is 0.6 at a wavelength of 550 nm;

### DETAILED DESCRIPTION

The present disclosure will be described in detail with reference to the accompanying drawings so that those skilled in the technical field to which the present disclosure pertains may easily implement the present disclosure. However, the present disclosure may be implemented in many different forms and is not limited to the embodiments described herein.

To clearly explain the present disclosure in the drawings, parts that are not related to the description are omitted, and identical or similar components are given the same reference numerals throughout the disclosure. The length and thickness of each component in the drawings are for illustrative purposes only, and the present disclosure is not limited to the length and thickness shown in the drawings.

The terminology used herein is for the purpose of describing exemplary embodiments only and is not intended to limit the present disclosure. As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure.”

In the present disclosure, “in-plane retardation (Re)” may be expressed as Equation A, “thickness direction retardation (Rth)” may be expressed as Equation B, and “degree of biaxiality (NZ)” may be expressed as Equation C:

$$Re = ( n x - ny ) \times d \qquad Equation A$$

$$Rth = ( ( n x + ny ) / 2 - nz ) \times d \qquad Equation B$$

$$NZ = ( n x - nz ) / ( nx - n y ) . \qquad Equation C$$

In Equations A to C, nx, ny, and nz are refractive indexes of an optical element at a measurement wavelength in a slow axis direction, a fast axis direction, and a thickness direction, respectively, and d is a thickness of the optical element (units: nm). In Equations A to C, the measurement wavelength may be any specific wavelength from 450 nm to 650 nm.

In the present disclosure, unless specifically mentioned, nx, ny, and nz, may refer to refractive indexes of an optical element at a wavelength of 550 nm in a slow axis direction (the axis with the maximum refractive index in the in-plane direction), a fast axis direction (the axis with the minimum refractive index in the in-plane direction), and in a thickness direction, respectively.

In the present disclosure, when describing an angle, “+” refers to the counterclockwise direction with respect to the reference, and “−” refers to the clockwise direction with respect to the reference.

In the present disclosure, “(meth)acrylic” may refer to acrylic and/or methacrylic.

In the present disclosure, when describing a numerical range, “X to Y” refers to “X or more and Y or less (X≤ and ≤Y).”

A polarizing plate according to one or more embodiments may include a single-layer retardation film. The polarizing plate improves visibility across all azimuths, minimizes or reduces color changes, reduces light transmittance across all azimuths, and exhibits an excellent and beneficial thickness-thinning effect. As used herein, ‘reducing the light transmittance’ refers to reducing the degree of light transmission emitted across all azimuths when a polarizing plate is applied to an optical display apparatus and driven, thereby preventing light leakage. The lower the maximum value of light transmittance, the more beneficial it is. In one or more embodiments, the maximum value of light transmittance when driving the polarizing plate may be about 0.5% or less, for example, 0 to about 0.5% or about 0.1% to about 0.5%.

A polarizing plate according to one or more embodiments may include a single-layer retardation film, and the polarizing plate allows roll-to-roll manufacturing, thereby improving processability and economic feasibility in manufacturing polarizing plates.

A polarizing plate of one or more embodiments may include a polarizer and a retardation layer on (e.g., laminated on) a (e.g., one) surface of the polarizer, wherein the retardation layer may include a retardation film satisfying nx>nz>ny at a wavelength of 550 nm (Here, nx, ny, and nz refer to the refractive index of a retardation film in a slow axis direction, the refractive index in a fast axis direction, and the refractive index in a thickness direction at a wavelength of 550 nm, respectively.), an orientation direction of a main chain of a resin contained in the retardation film is about −5° to about +5° relative to a light absorption axis of the polarizer, and the retardation film has a degree of biaxiality of about 0.3 to about 0.7 at a wavelength of 550 nm.

In one or more embodiments, the retardation layer may be laminated on a light incident surface of an internal light of the polarizer. Here, the ‘light incident surface of the internal light of the polarizer’ is a surface on which light emitted from a panel for an optical display apparatus is incident on the polarizer, and the internal light may be light emitted from a backlight unit.

The polarizing plate may be a viewer-side polarizing plate or a light source-side polarizing plate.

According to one or more embodiments, the retardation layer may be positioned between a polarizer of a viewer-side polarizing plate and a panel for an optical display apparatus (e.g., a liquid crystal panel). In one or more embodiments, a light absorption axis of a polarizer in the viewer-side polarizing plate and the orientation direction of the liquid crystal of the panel may be substantially orthogonal.

According to one or more embodiments, the retardation layer may be positioned between a polarizer of a light source-side polarizing plate and a panel for an optical display apparatus. In one or more embodiments, a light absorption axis of a polarizer in the light source-side polarizing plate and the orientation direction of the liquid crystal of the panel may be substantially orthogonal.

The retardation film is a single-layer retardation film. This has an effect of thinning the thickness of a polarizing plate and improving processability and economic feasibility in manufacturing polarizing plates. Here, ‘single-layer retardation film’ refers to a retardation film including (e.g., consisting of) only one layer, without two or more layers joined by an adhesive layer or a bonding layer.

According to one or more embodiments, the retardation film may have a thickness of about 40 micrometers (μm) to about 100 μm, for example, about 40 μm, about 45 μm, about 50 μm, about 55 μm, about 60 μm, about 65 μm, about 70 μm, about 75 μm, about 80 μm, about 85 μm, about 90 μm, about 95 μm, or about 100 μm, for example, about 40 μm to about 80 μm. Within the above range, the retardation film may be applied to a polarizing plate and provide a thickness-thinning effect.

In one or more embodiments, the retardation layer may include (e.g., consist of) only a retardation film. This has an effect of thinning the thickness of a polarizing plate and improving processability and economic feasibility in manufacturing polarizing plates.

According to one or more embodiments, the polarizing plate may have only a retardation film between a polarizer and an adherend (for example, a panel for an optical display apparatus). In one or more embodiments, in a polarizing plate, an adhesive layer, a retardation film, and an adhesive layer may be sequentially laminated on one surface of a polarizer, and the adhesive layer may be adhered to the adherend.

According to one or more embodiments, the polarizing plate may have a retardation film and one or more lower protective layers between a polarizer and an adherend (for example, a panel for an optical display apparatus). A lower protective layer may be present between a polarizer and a retardation film and/or between a retardation film and an adherend. In one or more embodiments, in a polarizing plate, an adhesive layer, a retardation film, a lower protective layer, and an adhesive layer may be sequentially laminated on one surface of a polarizer, and the adhesive layer may be adhered to the adherend.

In one or more embodiments, the lower protective layer may have an in-plane retardation of about 10 nanometers (nm) or less at a wavelength of 550 nm, for example, about 0 nm, about 1 nm, about 2 nm, about 3 nm, about 4 nm, about 5 nm, about 6 nm, about 7 nm, about 8 nm, about 9 nm, or about 10 nm, for example, 0 to about 10 nm. Within the above range, an effect of protecting a polarizer may be provided without affecting the function and effect of the retardation film. The lower protective layer may be an optically transparent film or coating layer. For example, in one or more embodiments, the lower protective layer may be a film made of one or more resins selected from among a cellulose-based resin including triacetylcellulose (TAC), a polyester-based resin including polyethylene terephthalate (PET), polybutylene terephthalate, polyethylene naphthalate, and polybutylene naphthalate, a cyclic olefin copolymer (COC)-based resin, a cyclic olefin polymer (COP)-based resin, a polycarbonate-based resin, a polyethersulfone-based resin, a polysulfone-based resin, a polyamide-based resin, a polyimide-based resin, a polyolefin-based resin, a polyarylate-based resin, a polyvinyl alcohol-based resin, a polyvinyl chloride-based resin, a polyvinylidene chloride-based resin, and an acrylic resin.

The retardation film satisfies nx>nz>ny at a wavelength of 550 nm (Here, nx, ny, and nz refer to the refractive index of the retardation film in a slow axis direction, the refractive index in a fast axis direction, and the refractive index in a thickness direction at a wavelength of 550 nm, respectively.), and the orientation direction of the main chain of a resin contained in the retardation film is −5° to +5^{°} relative to a light absorption axis of the polarizer. This makes it easy to improve visibility across all azimuths, minimize color changes, and reduce light transmittance across all azimuths, even when a polarizing plate is a single layer and has a retardation film satisfying nx>nz>ny at a wavelength of 550 nm.

The retardation film satisfies nx>nz>ny at a wavelength of 550 nm. This ensures nx>ny and 0<(nx−nz)/(nx−ny)<1, so that when the retardation film is used, there may be little change depending on the viewing angle, and when applied to a birefringent optical display panel, it may help improve the contrast ratio or visibility in black-and-white display and reduce color changes.

According to one or more embodiments of the present disclosure, (nx−ny) may be about 0.0022 to about 0.0075, for example, about 0.0022, about 0.0025, about 0.0030, about 0.0035, about 0.0040, about 0.0045, about 0.0050, about 0.0055, about 0.0060, about 0.0065, about 0.0070, or about 0.0075, for example about 0.00275 to about 0.0075, and (nx−nz) may be about 0.00066 to about 0.00525, for example, about 0.00066, about 0.00070, about 0.00080, about 0.00090, about 0.0010, about 0.0015, about 0.0020, about 0.0025, about 0.0030, about 0.0035, about 0.0040, about 0.0045, about 0.0050, or about 0.00525, for example, about 0.000825 to about 0.00525. Within the above range, when a retardation film is used, there is little change depending on the viewing angle, and when applied to a birefringent optical display panel, it may help improve the contrast ratio or visibility in black-and-white display.

According to one or more embodiments of the present disclosure, in the retardation film, nx may be about 1.500 to about 1.710, for example, about 1.500, about 1.550, about 1.600, about 1.650, about 1.700, or about 1.710, for example, about 1.500 to about 1.705, and ny may be about 1.480 to about 1.700, for example, about 1.480, about 1.500, about 1.550, about 1.600, about 1.650, or about 1.700, for example, about 1.485 to about 1.700, and nz may be about 1.500 to about 1.705, for example, about 1.500, about 1.550, about 1.600, about 1.650, about 1.700, or about 1.705, for example, about 1.500 to about 1.700. In the above range, the above-mentioned ranges of (nx−ny) and (nx−nz) can be easily reached, and manufacturing of the retardation film may be easy.

In the retardation film, the orientation direction of the main chain of a resin contained in the retardation film is about −5° to about +5° relative to a light absorption axis of the polarizer. This ensures that the retardation film is manufactured from a composition for a retardation film described herein and that the retardation film satisfies the optical properties described herein, thereby providing an effect of improving visibility across all azimuths and reducing light transmittance across all azimuths.

According to one or more embodiments, the orientation direction of the main chain of a resin contained in the retardation film may be about −3° to about +3° and about 0° relative to a light absorption axis of the polarizer. Within the above range, the above-described effects may be easily obtained.

A main chain orientation direction (i.e., orientation direction of the main chain) of a resin contained in the retardation film may be measured by a suitable method known to those skilled in the art. For example, the main chain orientation direction may be confirmed visually by checking the grain in a stretching direction of the retardation film. For example, the main chain orientation direction may be confirmed through measurement of the crystal structure of the resin in the retardation film by X-ray measurement of the retardation film (e.g., X-ray diffraction (X-RD)), measurement of the dynamic structure of the resin in the retardation film by NMR measurement of the retardation film, and/or measurement of the orientation direction by Raman and infrared spectroscopy measurements. The light absorption axis of the polarizer may be a machine direction of the polarizer.

An angle between the orientation direction of the main chain of the resin contained in the retardation film and the light absorption axis of the polarizer may be implemented by adjusting an angle between the main chain orientation direction and the light absorption axis of the polarizer when laminating the retardation film on the polarizer.

According to one or more embodiments, the retardation film has a degree of biaxiality of about 0.3 to about 0.7 at a wavelength of 550 nm. When the degree of biaxiality is less than 0.3, the light transmittance in a black state increases across all viewing angles, which may result in poor black viewing. When the degree of biaxiality exceeds 0.7, the light transmittance in a black state increases across all viewing angles, which may result in poor black viewing. For example, in one or more embodiments, the degree of biaxiality may be about 0.3, about 0.31, about 0.32, about 0.33, about 0.34, about 0.35, about 0.36, about 0.37, about 0.38, about 0.39, about 0.4, about 0.41, about 0.42, about 0.43, about 0.44, about 0.45, about 0.46, about 0.47, about 0.48, about 0.49, about 0.5, about 0.51, about 0.52, about 0.53, about 0.54, about 0.55, about 0.56, about 0.57, about 0.58, about 0.59, about 0.6, about 0.61, about 0.62, about 0.63, about 0.64, about 0.65, about 0.66, about 0.67, about 0.68, about 0.69, or about 0.7, for example, about 0.4 to about 0.6, and within the above range, the effect may be significantly excellent and beneficial.

According to one or more embodiments, in the retardation film, a value of Expression 1 may be about 0.8 to about 1.2, and a value of Expression 2 may be about 0.9 to about 1.1. Within the above ranges of the values of Expression 1 and Expression 2, the retardation film may be manufactured from a composition for a retardation film described herein, and it may be easy to provide an effect of improving visibility across all viewing angles and reducing light transmittance in a black state across all viewing angles. For example, in one or more embodiments, the value of Expression 1 may be about 0.8, about 0.85, about 0.9, about 0.95, about 1.0, about 1.05, about 1.1, about 1.15, or about 1.2, for example, about 0.9 to about 1.1, and the value of Expression 2 may be about 0.9, about 0.95, about 1.0, about 1.05, or about 1.1, for example, about 0.95 to about 1.05.

$$Re ( 450 nm ) / Re ( 550 nm ) \qquad Expression 1$$

$$Re ( 650 nm ) / Re ( 550 nm ) \qquad Expression 2$$

In Expression 1 and Expression 2, Re (450 nm), Re (550 nm), and Re (650 nm) are in-plane retardations (units: nm) of the retardation film at wavelengths of 450 nm, 550 nm, and 650 nm, respectively.

According to one or more embodiments, the retardation film has an in-plane retardation at a wavelength of 450 to 650 nm of about 220 nm to about 300 nm, for example, about 220 nm, about 225 nm, about 230 nm, about 235 nm, about 240 nm, about 245 nm, about 250 nm, about 255 nm, about 260 nm, about 265 nm, about 270 nm, about 275 nm, about 280 nm, about 285 nm, about 290 nm, about 295 nm, or about 300 nm, for example, about 250 nm to about 280 nm. Within the above range, the values of Expression 1 and Expression 2 may be easily reached, and it may be easy to provide an effect of reducing the light transmittance across all azimuths.

According to one or more embodiments, the retardation film may have an in-plane retardation of about 220 nm to about 300 nm and a degree of biaxiality of about 0.3 to about 0.7 at a wavelength of 550 nm. Within the above range, it may be easy to provide an effect of reducing light transmittance across all azimuths. For example, in one or more embodiments, the in-plane retardation may be about 220 nm, about 225 nm, about 230 nm, about 235 nm, about 240 nm, about 245 nm, about 250 nm, about 255 nm, about 260 nm, about 265 nm, about 270 nm, about 275 nm, about 280 nm, about 285 nm, about 290 nm, about 295 nm, or 300 nm, and, in one or more embodiments, about 250 nm to about 280 nm, the degree of biaxiality may be about 0.3, about 0.35, about 0.4, about 0.45, about 0.5, about 0.55, about 0.6, about 0.65, or about 0.7, for example, about 0.4 to about 0.6. Within the above range, light transmittance may be significantly reduced to 0.5% or less.

FIG. 3 shows light transmittance values (Y-axis, units: %) according to the degree of biaxiality (NZ) of a retardation film at a wavelength of 550 nm and the in-plane retardation (X-axis, units: nm) of the retardation film at a wavelength of 550 nm when a polarizing plate is mounted and driven in a transverse electric field method, for example, an in-plane switching (IPS) liquid crystal panel. In FIG. 3, ▪ is the light transmittance when the NZ of the retardation film is 0.4 at a wavelength of 550 nm, ● is the light transmittance when the NZ of the retardation film is 0.5 at a wavelength of 550 nm, and ▴ is the light transmittance when the NZ of the retardation film is 0.6 at a wavelength of 550 nm.

Referring to FIG. 3, it can be confirmed that when the in-plane retardation of the retardation film is 220 to 300 nm and the degree of biaxiality is 0.3 to 0.7 at a wavelength of 550 nm, especially, when the in-plane retardation is 250 to 280 nm and the degree of biaxiality is 0.4 to 0.6, light transmittance is significantly reduced to 0.5% or less.

The retardation film may be formed of a composition for a retardation film.

The composition for a retardation film may include one or more of the resins described previously and one or more of compounds represented by Chemical Formulas I to IV described below. The composition for a retardation film may make it easy to achieve the above-described optical properties.

In one or more embodiments, the resin may be a cellulose ester-based resin, and the resin may be included as a main component in the retardation film. Here, ‘main component’ may mean that the component is contained at about 70% by weight or more, for example, about 75% to about 99% by weight, or about 80% to about 99% by weight based on the solid content (e.g., amount) of the retardation film or the solid content of the composition for a retardation film.

The cellulose ester-based resin may include a cellulose ester-based resin in which the hydrogen of at least a part among hydroxyl groups (OH) of each of C2, C3, and C6 of cellulose is regioselectively substituted with one or more selected from among a plurality of aromatic-CO-groups as a substituent and a plurality of first unsaturated or saturated (C₁₋₆)alkyl-CO-groups as a substituent.

As used herein, an ‘aromatic-CO— group’ may be (i) a (C₆₋₂₀)aryl-CO— group in which the aryl group is unsubstituted or substituted with one to five R¹(s); or (ii) a heteroaryl-CO— group in which the heteroaryl group is a five- to ten-membered ring having one to four heteroatoms selected from N, O, and S, and the heteroaryl group is unsubstituted or substituted with one to five R¹(s). R¹ is defined as described herein.

In one or more embodiments, the cellulose ester-based resin may include a cellulose ester-based resin in which the hydrogen of at least a part among hydroxyl groups (OH) of each of C2, C3, and C6 of cellulose is regioselectively substituted with one or more selected from among a plurality of aromatic-CO-groups as a substituent and a plurality of first unsaturated or saturated (C₁₋₆)alkyl-CO-groups as a substituent, and at least a part among hydroxyl groups (OH) of each of C2, C3, and C6 is regioselectively unsubstituted.

According to one or more embodiments, the regioselectively substituted cellulose ester-based resin may include a plurality of alkyl-acyl or alkyl-CO-groups; a plurality of aryl-acyl or aryl-CO-groups; and a plurality of heteroaryl-acyl or heteroaryl-CO-groups.

In present disclosure, an acyl substituent or R—CO— group represents a substituent having the structure shown below:

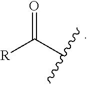

In a cellulose ester, these acyl or R—CO— groups may be bonded to a pyranose ring of cellulose through an ester bond (i.e. through an oxygen atom).

An aromatic-CO— group may be an acyl substituent having an aromatic-containing ring system. Examples thereof may include an aryl-CO— group and/or a heteroaryl-CO— group. Specific examples thereof may include a benzoyl group, a naphthoyl group, and a furoyl group, each of which may be unsubstituted or substituted.

The term “aryl-acyl” substituent represents an acyl substituent in which “R” is an aryl group. The term “aryl” refers to a monovalent group formed by removing a hydrogen atom from a cyclic carbon of an arene (i.e., a monocyclic or polycyclic aromatic hydrocarbon). In the present disclosure, an aryl-acyl group may be positioned before a carbon unit: for example, it may be a (C₅₋₆)aryl-acyl group, a (C₆₋₁₂)aryl-acyl group, or a (C₆₋₂₀)aryl-acyl. Examples of an aryl group suitable for use in various embodiments include, a phenyl group, a benzyl group, a tolyl group, a xylyl group, and a naphthyl group, but embodiments of the present disclosure are not limited thereto. These aryl groups may be substituted or unsubstituted.

The term “alkyl-acyl” represents an acyl substituent in which “R” is an alkyl group. “Alkyl” refers to a monovalent group of a non-aromatic hydrocarbon from which a hydrogen atom has been removed, and it may include a heteroatom. An alkyl group suitable for use herein may have a straight-chain form, a branched form, or a cyclic form, and may be saturated or unsaturated. An alkyl group suitable for use herein may include any (C₁₋₂₀), (C₁₋₁₂), (C₁₋₅), or (C₁₋₃)alkyl group. In some embodiments, an alkyl may be a C₁₋₅ straight-chain alkyl group. In some embodiments, an alkyl may be a C₁₋₃ straight-chain alkyl group. Non-limiting examples of a suitable alkyl group may include a methyl group, an ethyl group, a n-propyl group, an isopropyl group, a n-butyl group, an isobutyl group, a sec-butyl group, a tert-butyl group, a pentyl group, a hexyl group, an octyl group, a decyl group, a dodecyl group, a cyclopentyl group, and a cyclohexyl group. Non-limiting examples of an alkyl-acyl group may include an acetyl group, a propionyl group, and a butyroyl group.

The term “haloalkyl” refers to an alkyl substituent in which one or more hydrogens have each been replaced by a halogen. Carbon units of a haloalkyl group, for example, a halo(C₁₋₆)alkyl group, are often included. A haloalkyl group may have a straight-chain form or a branched form. Non-limiting examples of an haloalkyl group may include a chloromethyl group, a trifluoromethyl group, and a dibromo ethyl group.

The term “heteroalkyl” refers to an alkyl group in which one or more carbon atoms have each been replaced by a heteroatom such as N, O, and/or S.

The term “heteroaryl” refers to an aryl group in which one or more of carbon units of an aryl ring are each replaced by a heteroatom such as O, N, and/or S. A heteroaryl ring may be monocyclic or polycyclic. In one or more embodiments, a unit that makes up a heteroaryl ring system may include, for example, a 5- to 20-membered ring system. A five-membered heteroaryl group refers to a ring system with five atoms forming a heteroaryl ring. Non-limiting examples of a heteroaryl group may include a pyridinyl group, a quinolinyl group, a pyrimidinyl group, and a thiophenyl group.

The term “alkoxy” refers to an alkyl group terminally attached to an alkyl-O—or oxygen group. Often, a carbon unit such as an (C₁₋₆)alkoxy group may be included. Non-limiting examples of an alkoxy group may include a methoxy group, an ethoxy group, and a propoxy group.

The term “haloalkoxy” refers to an alkoxy group in which one or more of the hydrogens have each been replaced by a halogen. Often, a carbon unit such as a halo(C₁₋₆)alkoxy group is included. Non-limiting examples of a haloalkoxy group may include a trifluoromethoxy group, a bromomethoxy group, and a 1-bromo-ethoxy group.

The term “halo” refers to a halogen such as a fluoro group, a chloro group, a bromo group, and/or an iodo group.

In the present disclosure, the term “degree of substitution (DS)” is used to describe the level of substitution of a sugar substituent that is an anhydroglucose unit (“AGU”). In general, conventional cellulose includes three hydroxyl groups that may be substituted in each AGU. Therefore, DS may have a value from 0 to 3. However, a low-molecular weight cellulose mixed ester may have a total degree of substitution that is slightly higher than 3 from end group contributions. Since DS is a statistical average value, a value of 1 does not mean that all AGUs have a single substituent. In some embodiments, there may be unsubstituted anhydroglucose units, while some may have two and others may have three substituents, and it is more often the embodiment that the value is not an integer. The total DS is defined as the average number of all substituents per anhydroglucose unit. The degree of substitution per AGU may also refer to a specific substituent such as a hydroxyl group, an acetyl group, a butyryl group, or a propionyl group. In one or more embodiments, the degree of substitution may indicate carbon units of an anhydroglucose unit.

When the degree of substitution refers to a hydroxyl group (i.e., degree of substitution with hydroxyl groups, DS_{OH}), the reference means the average number of hydroxyl groups per unsubstituted anhydroglucose. As a result, DS_{OH} is not used in calculating the total degree of substitution.

Regioselectivity may be measured by determining the relative degree of substitution (“RDS”) at C6, C3, and C2 of a cellulose ester by carbon-13 NMR spectroscopy. In the case of a single type of acyl substituent or when a second acyl substituent is present in a small amount (DS<0.2), RDS may be most easily measured in a direct manner by integration of ring carbons. When two or more acyl substituents are present in similar amounts, in addition to determining the ring RDS, it may be necessary to completely substitute the cellulose ester with additional substituents to measure the RDS of each substituent independently by integration of carbonyl carbons. In conventional cellulose esters, regioselectivity is generally not observed, and the RDS ratio of C6/C3, C6/C2, or C3/C2 is generally close to 1 or less. Essentially, conventional cellulose esters are random copolymers. In contrast, when one or more acylation reagents are added to cellulose dissolved in an appropriate solvent, the C6 position of the cellulose is acylated much faster than the C2 and C3 positions. As a result, the C6/C3 and C6/C2 ratios are much greater than 1, which is a characteristic of 6,3- or 6,2-enhanced regioselectively substituted cellulose esters.

According to one or more embodiments, a cellulose ester generally includes the following structure:

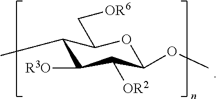

In the above structure, R², R³, and R⁶ may each independently be hydrogen (However, R², R³, and R⁶ may not be hydrogen at the same time) or an alkyl-acyl group or an aryl-acyl group bonded to the cellulose through an ester bond, and n is an integer greater than or equal to 1).

The degree of polymerization (“DP”) (e.g., the value of n) of cellulose esters prepared may be 10 or higher, 50 or higher, 100 or higher, or 250 or higher.

An acylation reagent may include an alkyl or aryl carboxylic acid anhydride, a carboxylic acid halide, and/or a carboxylic acid ester containing the above-described alkyl or aryl group suitable for use in an acyl substituent of the regioselectively substituted cellulose esters described herein, but is not limited thereto. Examples of a suitable carboxylic acid anhydride may include acetic acid anhydride, propionic acid anhydride, butyric acid anhydride, pivaloyl anhydride, benzoic acid anhydride, and naphthoyl anhydride, but embodiments of the present disclosure are not limited thereto. Examples of a carboxylic acid halide may include a chloride or a bromide of an acetyl group, a propionyl group, a butyryl group, a pivaloyl group, a benzoyl group, and a naphthoyl group, but embodiments of the present disclosure are not limited thereto. Examples of a carboxylic acid ester may include a methyl ester of an acetyl group, a propionyl group, a butyryl group, a pivaloyl group, a benzoyl group, and a naphthoyl group, but embodiments of the present disclosure are not limited thereto. In one or more embodiments, an acylating agent may be one or more carboxylic acid anhydrides selected from the group consisting of acetic acid anhydride, propionic acid anhydride, butyric acid anhydride, pivaloyl anhydride, benzoyl anhydride, and naphthoyl anhydride.

In one or more embodiments, the cellulose ester-based resin may include a cellulose ester-based resin regioselectively substituted with one or more selected from among: a plurality of aromatic-CO-groups as a substituent; a plurality of first unsaturated or saturated (C₁₋₆)alkyl-CO-groups as a substituent; and a plurality of hydroxy groups as a substituent.

According to one or more embodiments, the cellulose ester-based resin may have a degree of substitution for a hydroxy group of about 0.2 to about 2.0, a degree of substitution at C2 of about 0.15 to about 0.8, a degree of substitution at C3 of about 0.05 to about 0.6, and a degree of substitution at C6 of about 0.05 to about 0.6, and a total degree of substitution of about 0.25 to about 2.5.

According to one or more embodiments, the cellulose ester-based resin may have a degree of substitution for a hydroxy group of about 0.2 to about 2.0, a degree of substitution at C2 with an aromatic-CO group or an alkyl-CO group of about 0.15 to about 0.8, a degree of substitution at C3 with an aromatic-CO group or an alkyl-CO group of about 0.05 to about 0.6, a degree of substitution at C6 with an aromatic-CO group or an alkyl-CO group of about 0.05 to about 0.6, and a total degree of substitution with an aromatic-CO group and/or an alkyl-CO group of about 0.25 to about 2.5.

In one or more embodiments, the cellulose ester-based resin may have a degree of substitution for a first unsaturated or saturated (C₁₋₆)alkyl-acyl substituent (“DS_{FAk}”) of about 0.7 to about 2.2. In one or more embodiments, a cellulose ester-based resin may have a degree of substitution for the first unsaturated or saturated (C₁₋₆)alkyl-acyl substituent of about 0.7 to about 1.9.

In one or more embodiments, a first unsaturated or saturated (C₁₋₂₀)alkyl-CO—substituent may be an acetyl group, a propionyl group, a butyryl group, an isobutyryl group, a 3-methylbutanoyl group, a pentanoyl group, a 4-methylpentanoyl group, a 3-methylpentanoyl group, a 2-methylpentanoyl group, a hexanoyl group, or a crotonyl group. In one or more embodiments, the first unsaturated or saturated (C₁₋₆)alkyl-CO— substituent may be an acetyl group, a propionyl group, or a crotonyl group.

In one or more embodiments or in combination with any other embodiment, the cellulose ester-based resin may further include a plurality of second (C₁₋₂₀)alkyl-CO—substituents. In one or more embodiments, the degree of substitution for the second (C₁₋₂₀)alkyl-CO— substituent (“DS_{SAk}”) may be about 0.05 to about 0.6.

In one or more embodiments, the second (C₁₋₂₀)alkyl-CO— substituent may be an acetyl group, a propionyl group, a butyryl group, an isobutyryl group, a 3-methylbutanoyl group, a pentanoyl group, a 4-methylpentanoyl group, a 3-methyl pentanoyl group, a 2-methylpentanoyl group, a hexanoyl group, a pivalyl group, or a 2-ethylhexanoyl group. In one or more embodiments, the second (C₁₋₂₀)alkyl-CO-substituent may be an acetyl group, an isobutyryl group, a 3-methylbutanoyl group, a pentanoyl group, a 4-methylpentanoyl group, a 3-methylpentanoyl group, a 2-methyl pentanoyl group, a hexanoyl group, or a 2-ethylhexanoyl group. In one or more embodiments, the second (C₁₋₂₀)alkyl-CO— substituent may be an acetyl group or a 2-ethylhexanoyl group.

In one or more embodiments or in combination with any other embodiment, an aromatic-CO— group may be a (C₆₋₂₀)aryl-CO— group, wherein the aryl group may be unsubstituted or substituted with one to five R¹(s). In one or more embodiments, the aromatic-CO— group may be a benzoyl group or a naphthoyl group, which is unsubstituted or substituted with one to five R¹(s). In one or more embodiments, the aromatic-CO— group may be a benzoyl group unsubstituted or substituted with one to five R¹(s). In one or more embodiments, the aromatic-CO— group may be a naphthoyl group unsubstituted or substituted with one to five R¹(s).

In one or more embodiments or in combination with any other embodiment, the aromatic-CO— group may be a benzoyl group unsubstituted or substituted with R¹. In one or more embodiments, the cellulose ester-based resin has a total DS_{ArCO} Of about 0.40 to about 1.20. In one or more embodiments, the sum of C2DS_{ArCO} and C3DS_{ArCO} may be about 0.30 to about 0.75.

In one or more embodiments or in combination with any other embodiment, the aromatic-CO— group may be a naphthoyl group unsubstituted or substituted with one to five R¹(s). In one or more embodiments, the cellulose ester-based resin has a total DS_{ArCO} of about 0.30 to about 0.6. In one or more embodiments, the sum of C2DS_{ArCO} and C3DS_{ArCO} may be about 0.20 to about 0.40. In one or more embodiments, the sum of C2DS_{ArCO} and C3DS_{ArCO} may be about 0.30 to about 0.40.

In one or more embodiments or in combination with any other embodiment, the aromatic-CO— group may be a heteroaryl-CO— group, wherein the heteroaryl group may be a five- to ten-membered ring having one- to four-heteroatoms independently selected from N, O, and S, and wherein the heteroaryl group may be unsubstituted or substituted with one to five R¹(s). In one or more embodiments, the heteroaryl-CO-group may be a pyridinyl-CO— group, a pyrimidinyl-CO— group, a furanyl-CO— group, or a pyrrolyl-CO— group. In one or more embodiments, the heteroaryl-CO— group may be a 2-furoyl group.

In one or more embodiments or in combination with any other embodiment, the cellulose ester-based resin has a totDS_{ArCO} (e.g., a total DS_{ArCO}) of about 0.4 to about 1.6. In one or more embodiments or in combination with any other embodiment, the cellulose ester-based resin has a totDS_{ArCO} (e.g., a total DS_{ArCO}) of about 1.0 to about 1.6. In one or more embodiments or in combination with any other embodiment, the cellulose ester-based resin has a totDS_{ArCO} (e.g., a total DS_{ArCO}) of about 0.3 to about 1.25. In one or more embodiments or in combination with any other embodiment, the cellulose ester-based resin has a totDS_{ArCO} (e.g., a total DS_{ArCO}) of about 0.4 to about 1.2. In one or more embodiments or in combination with any other embodiment, the cellulose ester-based resin has a totDS_{ArCO} (e.g., a total DS_{ArCO}) of about 0.4 to about 0.8. In one or more embodiments or in combination with any other embodiment, the cellulose ester-based resin has a totDS_{ArCO} (e.g., a total DS_{ArCO}) of about 0.3 to about 0.8. In one or more embodiments or in combination with any other embodiment, the cellulose ester-based resin has a totDS_{ArCO} (e.g., a total DS_{ArCO}) of about 0.3 to about 0.6. In one or more embodiments or in combination with any other embodiment, the cellulose ester-based resin has a totDS_{ArCO} (e.g., a total DS_{ArCO}) of about 0.2 to about 0.6. In one or more embodiments or in combination with any other embodiment, the cellulose ester-based resin has a totDS_{ArCO} (e.g., a total DS_{ArCO}) of about 0.2 to about 0.5. In one or more embodiments or in combination with any other embodiment, the cellulose ester-based resin has a totDS_{ArCO} (e.g., a total DS_{ArCO}) of about 0.8 to about 1.2. In one or more embodiments or in combination with any other embodiment, the cellulose ester-based resin has a totDS_{ArCO} (e.g., a total DS_{ArCO}) of about 0.5 to about 1.1.

In one or more embodiments or in combination with any other embodiment, the DS_{OH} is about 0.3 to about 1.0. In one or more embodiments or in combination with any other embodiment, the DS_{OH} is about 0.3 to about 0.9. In one or more embodiments or in combination with any other embodiment, the DS_{OH} is about 0.4 to about 0.9. In one or more embodiments or in combination with any other embodiment, the DS_{OH} is about 0.5 to about 0.9. In one or more embodiments or in combination with any other embodiment, the DS_{OH} is about 0.6 to about 0.9. In one or more embodiments or in combination with any other embodiment, the DS_{OH} is about 0.4 to about 0.8. In one or more embodiments or in combination with any other embodiment, the DS_{OH} is about 0.5 to about 0.8.

In one or more embodiments or in combination with any other embodiment, the sum of C2DS_{ArCO} and C3DS_{ArCO} is about 0.3 to about 1.25. In one or more embodiments or in combination with any other embodiment, the sum of C2DS_{ArCO} and C3DS_{ArCO} is about 0.2 to about 0.4. In one or more embodiments or in combination with any other embodiment, the sum of C2DS_{ArCO} and C3DS_{ArCO} is about 0.3 to about 0.4. In one or more embodiments or in combination with any other embodiment, the sum of C2DS_{ArCO} and C3DS_{ArCO} is about 0.4 to about 1.2. In one or more embodiments or in combination with any other embodiment, the sum of C2DS_{ArCO} and C3DS_{ArCO} is about 0.4 to about 1.1. In one or more embodiments or in combination with any other embodiment, the sum of C2DS_{ArCO} and C3DS_{ArCO} is about 0.4 to about 1.0. In one or more embodiments or in combination with any other embodiment, the sum of C2DS_{ArCO} and C3DS_{ArCO} is about 0.5 to about 1.1. In one or more embodiments or in combination with any other embodiment, the sum of C2DS_{ArCO} and C3DS_{ArCO} is about 0.6 to about 1.0. In one or more embodiments or in combination with any other embodiment, the sum of C2DS_{ArCO} and C3DS_{ArCO} is about 0.6 to about 1.25. In one or more embodiments or in combination with any other embodiment, the sum of C2DS_{ArCO} and C3DS_{ArCO} is about 0.30 to about 0.75.

In one or more embodiments, the composition for a retardation film, that is, the retardation film, may further include component A which includes one or more selected from compounds represented by Chemical Formulas I to IV:

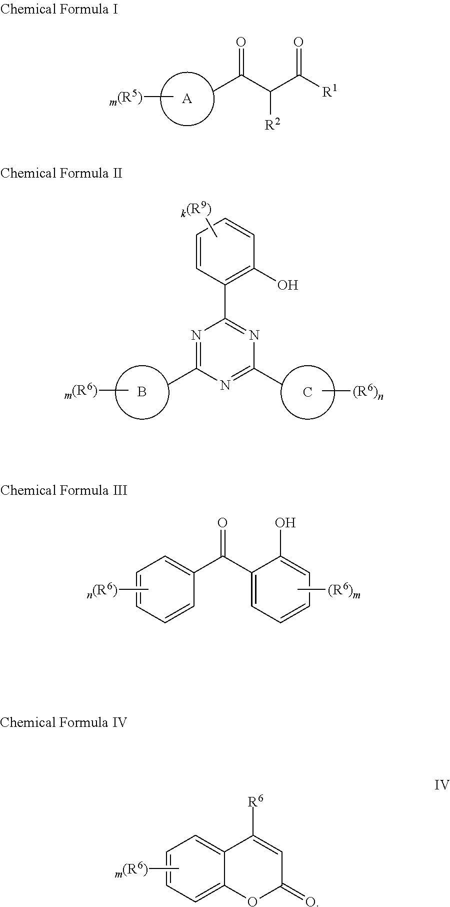

In Chemical Formulas I to IV,
Ring A may be a (C₆₋₂₀)aryl group or a five- to ten-membered heteroaryl group containing one to four heteroatoms independently selected from N, O, and S;
Ring B may be a (C₆₋₂₀)aryl group or a five- to ten-membered heteroaryl group containing one to four heteroatoms independently selected from N, O, and S;
Ring C may be a (C₆₋₂₀)aryl group or a five- to ten-membered heteroaryl group containing one to four heteroatoms independently selected from N, O, and S;
R¹ may be: a saturated or unsaturated (C₁₋₂₀)alkyl group; a saturated or unsaturated halo(C₁₋₂₀)alkyl group; a (C₆₋₂₀)aryl group optionally substituted one to five times with an alkyl group, a haloalkyl group, an alkoxy group, a haloalkoxy group, and/or a halo group; a five- to ten-membered heteroaryl group containing one to four heteroatoms independently selected from N, O, and S; or —CH₂C(O)—R³;
R² may be independently hydrogen, a saturated or unsaturated (C₁₋₂₀)alkyl group, or a saturated or unsaturated halo(C₁₋₂₀)alkyl group;
R³ may be a saturated or unsaturated (C₁₋₂₀)alkyl group, a saturated or unsaturated halo(C₁₋₂₀)alkyl group, a (C₆₋₂₀)aryl group, or a five- to ten-membered heteroaryl group containing one to four heteroatoms independently selected from N, O, and S, wherein the aryl group or the heteroaryl group may be unsubstituted or substituted with one to five R⁶(s);
R⁴ may be a saturated or unsaturated (C₁₋₂₀)alkyl group, a saturated or unsaturated halo(C₁₋₂₀)alkyl group, or a saturated or unsaturated (C₁₋₂₀)alkyl-CO—(C₁₋₂₀)alkyl group, wherein each group may be independently unsubstituted or substituted with one to three hydroxyl groups, a saturated or unsaturated (C₁₋₂₀)alkyl group, a saturated or unsaturated halo(C₁₋₂₀)alkyl group, a saturated or unsaturated (C₁₋₂₀)alkoxy group, a saturated or unsaturated halo(C₁₋₂₀)alkoxy group, a saturated or unsaturated hydroxy(C₁₋₂₀)alkyl group, a saturated or unsaturated (C₁₋₂₀)alkoxy-(C₁₋₂₀)alkyl group, a saturated or unsaturated (C₁₋₂₀)alkoxy-hydroxy(C₁₋₂₀)alkyl group, a saturated or unsaturated (C₁₋₂₀)alkoxy-(C₁₋₂₀)alkyl-CO—(C₁₋₂₀)alkyl group, a saturated or unsaturated (C₁₋₂₀)alkyl-CO group, a saturated or unsaturated (C₁₋₂₀)alkyl-COO group, a saturated or unsaturated (C₁₋₂₀)alkyl-O—CO—(C₁₋₂₀)alkyl group, a saturated or unsaturated (C₁₋₂₀)alkyl-COO—(C₁₋₂₀)alkyl group, a saturated or unsaturated (C₁₋₂₀)alkoxy-(C₁₋₂₀)alkyl-COO—(C₁₋₂₀)alkyl group, or a (C₁₋₂₀)alkoxy-(C₁₋₂₀)alkyl-O—CO—(C₁₋₂₀)alkyl group;
Each R⁵ may be independently a hydroxy group, a cyano group, a saturated or unsaturated (C₁₋₂₀)alkyl group, a saturated or unsaturated halo(C₁₋₂₀)alkyl group, a saturated or unsaturated (C₁₋₂₀)alkoxy group, a saturated or unsaturated halo(C₁₋₂₀) alkoxy group, or a halo group;
Each R⁶ may be independently a hydroxy group, a cyano group, a saturated or unsaturated (C₁₋₂₀)alkyl group, a saturated or unsaturated halo(C₁₋₂₀)alkyl group, a saturated or unsaturated (C₁₋₂₀)alkoxy group, a saturated or unsaturated halo(C₁₋₂₀)alkoxy group, or a halo group, or a (C₆₋₂₀)aryl group, wherein the aryl group may be unsubstituted or substituted with one to five R⁷(s);
Each R⁷ may be independently a hydroxyl group, a saturated or unsaturated (C₁₋₆)alkyl group, a saturated or unsaturated halo(C₁₋₆)alkyl group, or a saturated or unsaturated (C₁₋₆)alkoxy group;
R⁸ may be a saturated or unsaturated (C₁₋₂₀)alkyl group, a saturated or unsaturated halo(C₁₋₂₀)alkyl group, a saturated or unsaturated (C₁₋₂₀)alkoxy group, or a saturated or unsaturated halo(C₁₋₂₀)alkoxy group; and
Each R⁹ may be an R⁴—O— group, a hydroxy group, a saturated or unsaturated (C₁₋₂₀)alkyl group, a saturated or unsaturated hetero(C₁₋₂₀)alkyl group containing one or two heteroatoms independently selected from N, O, and S, a saturated or unsaturated halo(C₁₋₂₀)alkyl group, a saturated or unsaturated (C₁₋₂₀)alkyl-CO—(C₁₋₂₀)alkyl- group, a saturated or unsaturated (C₁₋₂₀)alkyl-COO—(C₁₋₂₀)alkyl- group, a saturated or unsaturated (C₁₋₂₀)alkyl-COO— group, a saturated or unsaturated (C₁₋₂₀)alkyl-O—CO— group, a saturated or unsaturated (C₁₋₂₀)alkyl-CO— group, a saturated or unsaturated (C₁₋₂₀)alkoxy-(C₁₋₂₀)alkyl-CO—O—(C₁₋₂₀)alkyl group, a saturated or unsaturated (C₁₋₂₀)alkoxy-(C₁₋₂₀)alkyl-O—CO—(C₁₋₂₀)alkyl group, a saturated or unsaturated (C₁₋₂₀)alkoxy-(C₁₋₂₀)alkyl-COO—(C₁₋₂₀)alkyl group, a (C₁₋₂₀)alkoxy-(C₁₋₂₀)alkyl-O—CO—(C₁₋₂₀)alkyl-(C₆₋₁₀) aryl group, or a five- to ten-membered heteroaryl group containing one to four heteroatoms independently selected from N, O, and S;
wherein each group may be unsubstituted or substituted with one to three hydroxyl groups, saturated or unsaturated (C₁₋₂₀)alkyl groups, saturated or unsaturated halo(C₁₋₂₀)alkyl groups, saturated or unsaturated (C₁₋₂₀)alkoxyl groups, saturated or unsaturated halo(C₁₋₂₀)alkoxyl groups, saturated or unsaturated hydroxy(C₁₋₂₀)alkyl groups, saturated or unsaturated (C₁₋₂₀)alkoxy-(C₁₋₂₀)alkyl groups, saturated or unsaturated (C₁₋₂₀)alkoxy-hydroxy(C₁₋₂₀)alkyl groups, saturated or unsaturated (C₁₋₂₀) alkoxy-(C₁₋₂₀)alkyl-CO—(C₁₋₂₀)alkyl- groups, saturated or unsaturated (C₁₋₂₀)alkyl-CO groups, saturated or unsaturated (C₁₋₂₀)alkyl-COO groups, saturated or unsaturated (C₁₋₂₀)alkyl-O—CO—(C₁₋₂₀)alkyl groups, saturated or unsaturated (C₁₋₂₀)alkyl-COO—(C₁₋₂₀)alkyl groups, saturated or unsaturated (C₁₋₂₀)alkoxy-(C₁₋₂₀)alkyl-COO—(C₁₋₂₀)alkyl groups, or (C₁ 20)alkoxy-(C₁₋₂₀)alkyl-O—CO—(C₁₋₂₀)alkyl groups;
Each n may independently be 0, 1, 2, 3, 4 or 5;
Each m may independently be 0, 1, 2, 3 or 4;
k may be 0, 1, 3 or 4.

According to one or more embodiments, component A may be 1,3-diphenyl-1,3-propanedione, avobenzone, (2-hydroxy-4-(octyloxy)phenyl(phenyl)methanone, (2-hydroxy-4-methoxyphenyl)(2-hydroxyphenyl)methanone, 2-(4,6-diphenyl-1,3,5-triazin-2-yl)-5-(hexyloxy)phenol (Tinuvin 1577), 2-[4,6-bis(2,4-dimethylphenyl)-1,3,5-triazin-2-yl]-5-[2-hydroxy-3-(dodecyloxy- and tridecyloxy)propoxy]phenol (Tinuvin 400), isooctyl 2-(4-(4,6-di([1,1′-biphenyl]-4-yl)-1,3,5-triazin-2-yl)-3-hydroxyphenoxy)propanoate (Tinuvin 479), 6,6′-(6-(2,4-dibutoxyphenyl)-1,3,5-triazine-2,4-diyl)bis(3-butoxyphenol) (Tinuvin 460), 2-(4,6-bis(2,4-dimethylphenyl)-1,3,5-triazin-2-yl)-5-(3-((2-ethylhexyl)oxy)-2-hydroxypropoxy)phenol (Tinuvin 405), 7-diethylamino-4-methylcoumarin, or a (e.g., any suitable) combination of thereof.

According to one or more embodiments, component A may be present in an amount of about 1% by weight or more based on a total solid content of 100% by weight of the composition. In one or more embodiments, component A may be present in a range of about 1% to about 30% by weight based on the total solid content of 100% by weight of the composition. In one or more embodiments, component A may be present in a range of about 1% to about 20% by weight based on the total solid content of 100% by weight of the composition. In one or more embodiments, component A may be present in a range of about 1% to about 15% by weight based on the total solid content of 100% by weight of the composition. Within the above range, the effect of the present disclosure may be easily implemented.

In one or more embodiments, the composition for the retardation film may further include a plasticizer to increase the workability and flexibility of the retardation film. The plasticizer may be included in an amount of about 0.1% to about 10% by weight, for example, about 0.1% to about 5% by weight based on the total solid content of the retardation film or of the composition for a retardation film. Within the above range, the glass transition temperature and melting temperature of a material from which a retardation film is formed may be reduced, and manufacturing of the film at a lower temperature and/or manufacturing of a simplified film may be possible.

The plasticizer may be at least one selected from a phosphate type plasticizer, a phthalate type plasticizer, a terephthalate type plasticizer, a trimellitate type plasticizer, a benzoate type plasticizer, a glycolate type plasticizer, a citrate type plasticizer, a polyhydric alcohol ester type plasticizer, a polyol type plasticizer, a polyester type plasticizer, and/or the like.

Non-limiting examples of the glycolate type plasticizer may include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate.

According to one or more embodiments, the retardation film may be manufactured through solution casting and stretching of the composition for a retardation film. According to one or more embodiments, the retardation film may be manufactured by preparing a casting solution with the composition for a retardation film itself or by adding a solvent to the composition for a retardation film, applying the casting solution onto a substrate, and drying the same to manufacture an unstretched film, and stretching the unstretched film in a machine direction of the unstretched film.

In one or more embodiments, the orientation direction of the main chain of a resin contained in the retardation film may be adjusted by the viscosity of the composition for a retardation film, the concentration of the resin in the composition for a retardation film, etc., and the stretching direction and stretching ratio of the unstretched film when manufacturing the unstretched film.

In one or more embodiments, a slow axis of the retardation film may be about −5° to about +5⁰, for example, about −3° to about +3°, or about 0° relative to the light transmission axis of the polarizer. Within the above range, the effect of the present disclosure may be easily implemented.

In one or more embodiments, the slow axis of the retardation film may be substantially parallel to the transverse direction of the retardation film.

A polarizer may convert incident natural light or polarized light into linearly polarized light in a specific direction. The polarizer may have a thickness of about 2 μm to about 30 μm, and, in one or more embodiments, about 4 μm to about 25 μm, and may be used in the polarizing plate within this range.

A polarizer may be manufactured from a film containing a polyvinyl alcohol-based resin as a main component by a suitable method known to those skilled in the art. For example, the polarizer may be a polarizer manufactured by iodine dyeing and stretching. The polarizer may have a light absorption axis and a light transmission axis that is orthogonal to the light absorption axis in an in-plane direction, and the light absorption axis may be a machine direction (MD) and the light transmission axis may be a transverse direction (TD) (orthogonal to MD).

In one or more embodiments, the polarizing plate may further include an upper protective layer on an upper surface of the polarizer.

The upper protective layer may include one or more of an optically transparent protective coating layer and protective film. The protective coating layer may include a coating layer formed of a composition including an active energy ray-curable compound. The protective film may be an optically transparent film, for example, a film made of one or more resins selected from among a cellulose-based resin including triacetylcellulose (TAC), a polyester-based resin including polyethylene terephthalate (PET), polybutylene terephthalate, polyethylene naphthalate, and polybutylene naphthalate, a cyclic polyolefin-based resin, a polycarbonate-based resin, a polyethersulfone-based resin, a polysulfone-based resin, a polyamide-based resin, a polyimide-based resin, a polyolefin-based resin, a polyarylate-based resin, a polyvinyl alcohol-based resin, a polyvinyl chloride-based resin, and a polyvinylidene chloride-based resin. In one or more embodiments, TAC film and/or PET film may be used.

The upper protective layer may have a thickness of about 0.1 μm to about 100 μm, for example, about 5 μm to about 70 μm, or about 15 μm to about 45 μm, and may be used in the polarizing plate within this range.

The upper protective layer may be adhered to an adherend by an adhesive layer. If (e.g., when) there is no problem with the function of the polarizing plate even if the upper protective layer is omitted, the upper protective layer may not be provided.

In one or more embodiments, the polarizing plate may further include an adhesive layer on a lowermost surface thereof. The adhesive layer serves to attach the polarizing plate to a panel. The adhesive layer may be formed of a suitable adhesive composition known to those skilled in the art.

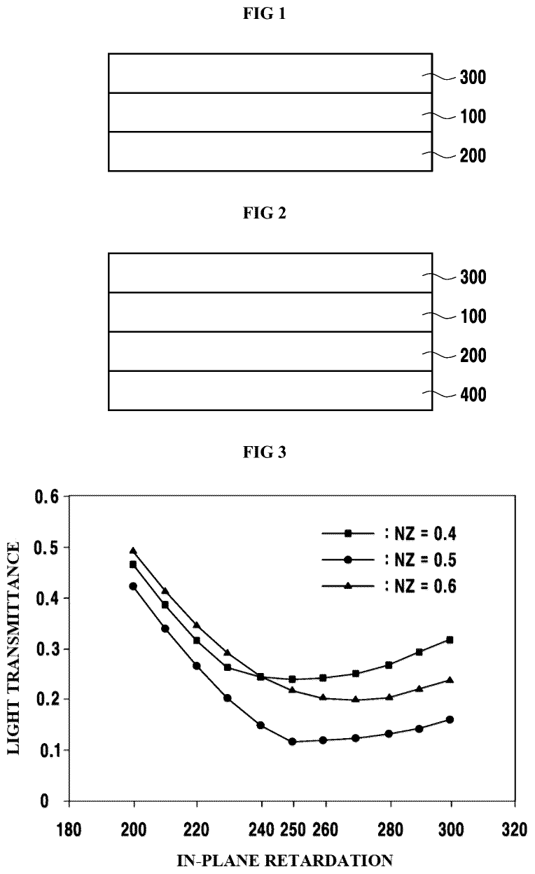

Referring to FIG. 1, in one or more embodiments, the polarizing plate may include a polarizer 100, an upper protective layer 300 on (e.g., laminated on) an upper surface of the polarizer 100, and a retardation film 200 on (e.g., laminated on) a lower surface of the polarizer 100.

Referring to FIG. 2, in one or more embodiments, the polarizing plate may include a polarizer 100, an upper protective layer 300 on (e.g., laminated on) an upper surface of the polarizer 100, and a retardation film 200 and a lower protective layer 400 sequentially on (e.g., laminated on) a lower surface of the polarizer 100.

### Optical Display Apparatus

According to one or more embodiments, an optical display apparatus may include the polarizing plate. The optical display apparatus may include a liquid crystal display apparatus. The polarizing plate may be included as a viewer-side polarizing plate in the optical display apparatus. In one or more embodiments, the liquid crystal display apparatus may be a liquid crystal display apparatus in an in-plane switching (IPS), fringe-field switching (FFS), advanced super dimension switching (ADS), or plane to line switching (PLS) mode as a homogeneous alignment mode.

According to one or more embodiments, the liquid crystal display apparatus may include a liquid crystal panel, a viewer-side polarizing plate on one side surface of the liquid crystal panel, and a light source-side polarizing plate on the other side surface of the liquid crystal panel. A light absorption axis of a polarizer in the viewer-side polarizing plate may be substantially orthogonal to a light absorption axis of the light source-side polarizing plate. When the light absorption axis of the polarizer in the viewer-side polarizing plate is 0°, the light absorption axis of the light source-side polarizing plate may be 90°, and a rubbing direction of the liquid crystal in the liquid crystal panel may be 90°.

Hereinafter, the configuration and operation of the present disclosure will be described in more detail through example embodiments of the present disclosure. However, these are presented as mere examples of the present disclosure and should not be construed as limiting the present disclosure in any way.

### Example 1

A composition for a retardation film (including a regioselectively substituted cellulose ester-based resin as a main component; EASTMAN Chemical Ltd.) including a regioselectively substituted cellulose ester-based resin (In the cellulose ester-based resin, the degree of C2 substitution with a propionyl group was 0.26, the degree of C3 substitution with a propionyl group was 0.34, the degree of C6 substitution with a propionyl group was 0.53, the total degree of substitution with a propionyl group was 2.33, and the degree of substitution with a hydroxyl group was 1.87.) was used to manufacture an unstretched film by a solution casting method. The manufactured unstretched film was stretched at a stretching ratio of 1.5 times in a machine direction of the unstretched film to manufacture a retardation film (in-plane retardation at a wavelength of 550 nm: 270 nm; degree of biaxiality: 0.6; thickness: 56 μm; nx=1.5323; ny=1.5275; and nz=1.5294).

A polyvinyl alcohol-based film (TS #20, Kuraray, Japan, thickness before stretching: 20 μm) was stretched 6 times uniaxially in a machine direction of the film in an iodine aqueous solution at 55° C. to manufacture a polarizer with a light transmittance of 45%.

A polarizing plate was manufactured by laminating a polyethylene terephthalate (PET) film with an anti-reflection layer on an upper surface of the manufactured polarizer, and laminating the manufactured retardation film on a lower surface of the polarizer. In the manufactured polarizing plate, an angle formed by the main chain orientation direction of the regioselectively substituted cellulose ester-based resin in the retardation film with respect to the light absorption axis of the polarizer (mechanical direction of the polarizer) was 0°.

### Examples 2 to 5

A polarizing plate was manufactured in substantially the same manner as in Example 1, except that the retardation film was changed by using a regioselectively substituted cellulose ester-based resin with a changed degree of substitution, changing the solution casting conditions, and changing the stretching ratio.

### Comparative Examples 1 to 4

A polarizing plate was manufactured in substantially the same manner as in Example 1, except that the retardation film was changed by using a regioselectively substituted cellulose ester-based resin with a changed degree of substitution, changing the solution casting conditions, and changing the stretching ratio.

The following physical properties were evaluated using each of the polarizing plates of Examples and Comparative Examples and are shown in Table 1.
(1) Optical properties of the retardation film: The optical properties of each of the retardation films were measured using AxoScan.
(2) Angle: An angle formed by the main chain orientation direction of the cellulose ester-based resin in the retardation film with respect to the light absorption axis of the polarizer (mechanical direction of the polarizer) in the polarizing plate was calculated as a relative angle between the light absorption axis and the main chain orientation direction by measuring the light absorption axis of the polarizer by AxoScan and measuring the main chain orientation direction of the cellulose ester-based resin by an X-ray diffraction (XRD) method in a state where the retardation film and the polarizer were separated.
(3) Maximum light transmittance (units: %): In a Samsung Electronics TV model provided with an IPS liquid crystal panel, the polarizing plate manufactured in each of Examples and Comparative Examples was attached and operated instead of the viewer-side polarizing plate. The maximum light transmittance in a black state was calculated across all viewing angles using the Extended Jones Matrix method using the TECHWIZ 1D (SANAI SYSTEM, KOREA) simulation software program. However, the reduction in light transmittance due to the color filter inside the panel was excluded from the above calculation. A lower maximum light transmittance means that light leakage may be prevented and visibility may be increased.
(4) Black visuality and color: In a Samsung Electronics TV model provided with an IPS liquid crystal panel, the polarizing plate manufactured in each of Examples and Comparative Examples was attached and operated instead of the viewer-side polarizing plate. In addition, black visuality and color were evaluated using visual evaluation methods.

TABLE 1

| | Examples | | | | | Comparative Examples | | | |
|---|---|---|---|---|---|---|---|---|---|
| | 1 | 2 | 3 | 4 | 5 | 1 | 2 | 3 | 4 |
| Re (nm) | 270 | 220 | 300 | 270 | 280 | 270 | 210 | 210 | 310 |
| NZ | 0.6 | 0.5 | 0.5 | 0.3 | 0.7 | 0.2 | 0.2 | 0.8 | 0.8 |
| Angle (°) | 0 | 0 | 0 | 0 | 0 | 0 | 0 | 0 | 0 |
| Retardation | 56 | 46 | 62 | 56 | 58 | 56 | 43 | 43 | 64 |
| film | | | | | | | | | |
| thickness | | | | | | | | | |
| (μm) | | | | | | | | | |
| Omni- | 0.25 | 0.27 | 0.13 | 0.41 | 0.48 | 0.74 | 0.86 | 0.99 | 0.82 |
| directional | | | | | | | | | |
| maximum | | | | | | | | | |
| light | | | | | | | | | |
| transmittance | | | | | | | | | |
| (%) | | | | | | | | | |
| Black | Excellent | Excellent | Excellent | Excellent | Excellent | Poor | Poor | Poor | Poor |
| visuality | | | | | | | | | |
| Color | Weak | Yellow | Blue | Weak | Weak | Strong | Weak | Weak | Weak |
| | blue | perceived | perceived | purple | yellow | yellow | yellow | yellow | purple |
| | and | | | perceived | and | perceived | perceived | perceived | perceived |
| | purple | | | | blue | | | | |
| | perceived | | | | perceived | | | | |

*The retardation films of Examples and Comparative Examples each satisfy nx > nz > ny at a wavelength of 550 nm.

As shown in Table 1, the polarizing plate of the present disclosure included a single-layer retardation film and provided an effect of improving visibility across all viewing angles, minimizing color changes, and ameliorating light leakage by reducing the maximum light transmittance in a black state across all viewing angles. On the other hand, as shown in Table 1, the above-described effect of the polarizing plate of Comparative Examples, which had the retardation film that did not satisfy the optical properties of the present disclosure, was lower compared to Examples.

According to one or more embodiments, provided is a polarizing plate that has a single-layer retardation film, improves visibility across all azimuths, and minimizes color changes.

According to one or more embodiments, provided is a polarizing plate that has a single-layer retardation film and reduces light transmittance across all azimuths.

According to one or more embodiments, provided is a polarizing plate that has an excellent thickness-thinning effect by having a single-layer retardation film.

According to one or more embodiments, provided is a polarizing plate that has a single-layer retardation film and allows roll-to-roll manufacturing.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof.

Throughout the present disclosure, when a component such as a layer, a film, a region, or a plate is mentioned to be placed “on” another component, it will be understood that it may be directly on another component or that another component may be interposed therebetween. In some embodiments, “directly on” may refer to that there are no additional layers, films, regions, plates, etc., between a layer, a film, a region, a plate, etc. and the other part. For example, “directly on” may refer to two layers or two members are disposed without utilizing an additional member such as an adhesive member therebetween.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

In the context of the present disclosure and unless otherwise defined, the terms “use,” “using,” and “used” may be considered synonymous with the terms “utilize,” “utilizing,” and “utilized,” respectively.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims and equivalents thereof.

What is claimed is:

1. A polarizing plate comprising:
a polarizer; and
a retardation layer on a first surface of the polarizer,
wherein the retardation layer comprises a retardation film satisfying nx>nz>ny at a wavelength of 550 nm, nx, ny, and nz being a refractive index of the retardation film in a slow axis direction, a refractive index of the retardation film in a fast axis direction, and a refractive index of the retardation film in a thickness direction, at a wavelength of 550 nm, respectively,
an orientation direction of a main chain of a resin contained in the retardation film is about −5° to about +5° relative to a light absorption axis of the polarizer, and
the retardation film has a degree of biaxiality of about 0.3 to about 0.7 at a wavelength of 550 nm.

2. The polarizing plate as claimed in claim 1, wherein the retardation film is a single-layer retardation film.

3. The polarizing plate as claimed in claim 1, wherein the retardation film has an in-plane retardation of about 220 nm to about 300 nm at a wavelength of 550 nm.

4. The polarizing plate as claimed in claim 1, wherein in the retardation film, a value of Expression 1 is about 0.8 to about 1.2, and a value of Expression 2 is about 0.9 to about 1.1,
$$Re ( 450 nm ) / Re ( 550 nm ) \qquad Expression 1$$
$$Re ( 650 nm ) / Re ( 550 nm ) \qquad Expression 2$$
in Expression 1 and Expression 2, Re (450 nm), Re (550 nm), and Re (650 nm) being in-plane retardations (units: nm) of the retardation film at wavelengths of 450 nm, 550 nm, and 650 nm, respectively.

5. The polarizing plate as claimed in claim 1, wherein a slow axis of the retardation film is about −5° to about +5° relative to a light transmission axis of the polarizer.

6. The polarizing plate as claimed in claim 1, wherein a slow axis of the retardation film is parallel to a transverse direction of the retardation film.

7. The polarizing plate as claimed in claim 1, wherein the retardation film is stretched in a machine direction (MD).

8. The polarizing plate as claimed in claim 1, wherein (nx−ny) is about 0.0022 to about 0.0075, and (nx−nz) is about 0.00066 to about 0.00525.

9. The polarizing plate as claimed in claim 1, wherein nx is about 1.500 to about 1.710, ny is about 1.480 to about 1.700, and nz is about 1.500 to about 1.705.

10. The polarizing plate as claimed in claim 1, wherein the resin is a main component of the retardation film.

11. The polarizing plate as claimed in claim 1, wherein the resin is a cellulose ester-based resin.

12. The polarizing plate as claimed in claim 11, wherein in the cellulose ester-based resin, hydrogen of at least a part among hydroxyl groups (OH) of each of C2, C3, and C6 of cellulose is regioselectively substituted with one or more selected from among a plurality of aromatic-CO-groups as a substituent and a plurality of first unsaturated or saturated (C₁₋₆)alkyl-CO-groups as a substituent.

13. The polarizing plate as claimed in claim 12, wherein the cellulose ester-based resin has a degree of substitution for a hydroxy group of about 0.2 to about 2.0, a degree of substitution at C2 of about 0.15 to about 0.8, a degree of substitution at C3 of about 0.05 to about 0.6, and a degree of substitution at C6 of about 0.05 to about 0.6, and a total degree of substitution of about 0.25 to about 2.5.

14. The polarizing plate as claimed in claim 1, wherein the retardation layer consists of the retardation film.

15. The polarizing plate as claimed in claim 1, wherein the retardation layer has a thickness of about 40 μm to about 100 μm.

16. The polarizing plate as claimed in claim 1, wherein a protective layer is on a second surface of the polarizer opposite the first surface of the polarizer.

17. An optical display apparatus comprising the polarizing plate as claimed in claim 1.
